(19) United States
(12) Patent Application Publication
(10) Pub. No.: US 2022/0097094 A1
(43) Pub. Date: Mar. 31, 2022

(54) FOUNTAIN

(71) Applicant: Samuel Kyun KIM, Fullerton, CA (US)

(72) Inventor: Samuel Kyun KIM, Fullerton, CA (US)

(21) Appl. No.: 17/491,368

(22) Filed: Sep. 30, 2021

Related U.S. Application Data
(60) Provisional application No. 63/085,809, filed on Sep. 30, 2020.

(51) Int. Cl. B05B 17/08; B05B 1/22

(52) U.S. Cl. CPC B05B 17/085; B05B 1/22

(57) ABSTRACT

A fountain includes a basin for storing water having a side and a bottom, and an access space formed by a cutout into the side of the basin. The access space has an access opening to inside of the basin. The fountain further includes a spout disposed over the basin and a spout support. The water falls from the spout to the basin, and the spout support connects the spout to the basin and supports the spout. A pump is disposed in the basin to pump the water in the basin to the spout through a water conduit, and the water conduit pass through the spout support such that the water conduit is not visible from outside. A water fill line passes through the access space and the access opening to the basin for supplying water to the basin.

### CROSS-REFERENCE TO RELATED APPLICATIONS

This application claims priority to U.S. provisional patent application No. 63/085,809 filed Sep. 30, 2020, which is incorporated herein by reference in its entirety.

### FIELD OF THE INVENTION

The present invention relates to a fountain and, more particularly, to a fountain having an access space and access opening for easy repair, maintenance and operation.

### BACKGROUND OF THE INVENTION

Fountains can bring joy to individual's lives. In essence, fountains are multimedia nature entertainment captured through the relaxing sound of flowing water and their aesthetically pleasing visual designs. The aesthetic beauty of fountains can elevate the senses and improve the well-being of their viewers. While the aesthetic beauty and the calmness exuded by fountain installs can ease the minds of their viewers, the installation and maintenance of fountains may be fraught with challenges.

Conventional fountains often require extensive excavations in the immediate area of their installations. For example, a significant amount of earth must be removed to make way for the installation of pumps, filters, power lines, and piping for inlets and outlets. Therefore, conventional fountains not only may have a large footprint but also, with components that are kept underground (particularly mechanical components like pumps), troubleshooting problems and issues may be costly and cumbersome if the mechanical components become damaged or require servicing.

Thus, there is a need for a fountain that can reduce their installation footprint while minimizing the amount of below-ground space requirements to make fountains easy to install and to service while not limiting their aesthetic beauty. The fountain of the present invention is provided to address this long-felt need.

### SUMMARY OF THE INVENTION

The present invention contrives to solve the problems of the prior art. The present invention provides a fountain having an access space that houses most or all of the required dry components for easy repair, maintenance and operation.

An object of this invention is to provide a fountain that includes a basin for storing water having a side and a bottom, and an access space formed by a cutout into the side of the basin. The access space has an access opening to inside of the basin. The fountain further includes a spout disposed over the basin and a spout support. The water falls from the spout to the basin, and the spout support connects the spout to the basin and supports the spout. A pump is disposed in the basin to pump the water in the basin to the spout through a water conduit, and the water conduit pass through the spout support such that the water conduit is not visible from outside. A water fill line passes through the access space and the access opening to the basin for supplying water to the basin.

Yet another object of this invention is provide a fountain that includes a lower basin for storing water, an access space formed by a cutout into the side of the lower basin, and an upper basin disposed over the lower basin. The lower basin has a side and a bottom, and the upper basin has a spout such that the water falls from the spout to the lower basin. The access space has an access opening to inside of the lower basin.

The fountain further includes an upper basin support connecting the upper basin to the lower basin and supporting the upper basin, a water conduit through which the water travels from the lower basin to the upper basin, a pump disposed in the lower basin to pump the water in the lower basin to the water conduit and then to the upper basin, a water fill line which passes through the access space and the access opening to the lower basin for supplying water to the lower basin, a power line for the pump which passes through the access space and the access opening to provide power to the pump, and a plurality of lighting sources installed on the upper basin. The water conduit passes through the upper basin support, and a power line for the lighting sources passes through the access space and the upper basin support to the lighting sources to provide power to the lighting sources.

Some of the advantages of the present invention are: (1) the fountain having an access space to house the dry components above ground rather than below ground to improve the ease of installing, repairing, maintaining, and operating the fountain; (2) the fountain having an access opening to provide easy access from the access space to inside of the basin for easy maintenance of the lower basin and pump; (3) the fountain is modular, which improves the ease and costs of transporting, placing, and setting up the fountain; (4) the fountain is easier to maintain, as the access space permits the fountain to being installed without extensive excavation of the install site and easy access; (5) the grating, when filled with pebbles and/or other material, provides cover to the basin that decreases evaporation of the collected water therein; (6) use of chemical treatment for the water is not necessary, which saves costs from having to connect the fountain to a sewage line; (7) the access space is separated and sealed from the basin, which prevents any leakage or water penetration to critical components of the fountain; and (8) the modular system allows fabrication of unique shapes and designs for the basin, the grating, the water tray, the spout support, and the upper ring (or upper basin) to provide unique fountain designs.

Although the present invention is briefly summarized, a fuller understanding of the invention can be obtained by the following drawings, detailed description and appended claims.

### BRIEF DESCRIPTION OF THE DRAWINGS

These and other features, aspects, and advantages of the present invention will become better understood with reference to the accompanying drawings, wherein:

FIGS. 1A and 1B show perspective views of a fountain having an access space according to one embodiment of the invention;

FIG. 2 shows a plan view thereof;

FIG. 3 shows a cross-sectional view of the fountain as indicated by line X of FIG. 1B;

FIG. 4A, 4B, and 4C show plan views of components of the fountain thereof, including FIG. 4A showing a plan view of the basin of the fountain, FIG. 4B showing a plan view of the grating of the fountain, and FIG. 4C showing a plan view of an upper ring of the fountain;

FIG. 5 shows a sectional view of the fountain thereof;

FIG. 6 shows exploded perspective views of the fountain thereof;

FIG. 7 shows a sectional view of a ring basin detail of the fountain thereof;

FIG. 8A shows a sectional of the angle support and grating of the fountain thereof;

FIG. 8B shows a plan view of the angle support of the fountain thereof; and

FIG. 9 shows a sectional view of the leveling mount.

### DETAILED DESCRIPTION OF THE EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations by use of the word “about”, it will be understood that the particular value forms another embodiment.

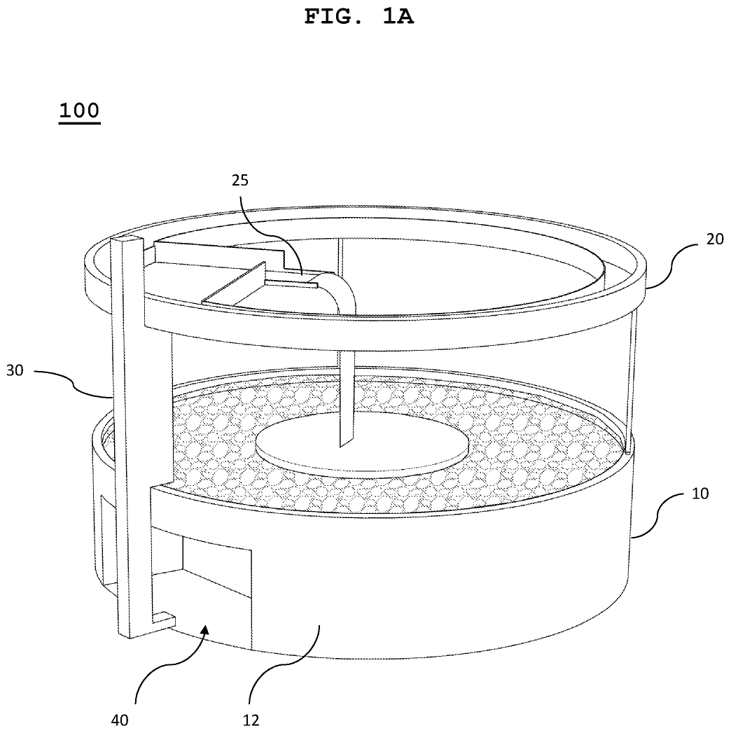

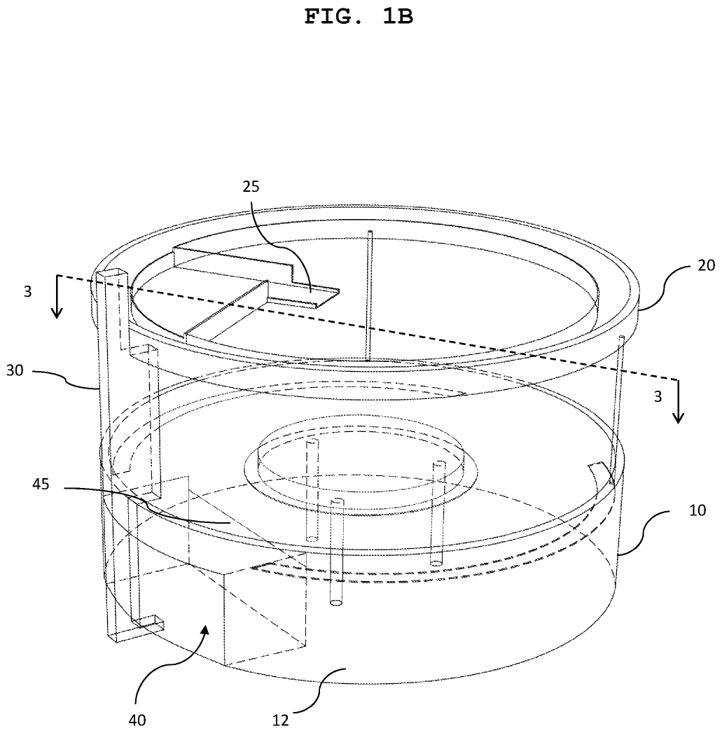

FIGS. 1A and 1B show an embodiment of the fountain 100, which includes a basin 10 for storing water having a side 12 and a bottom 14, and an access space 40 formed by a cutout into the side 12 of the basin 10. The access space 40 has an access opening 45 to inside of the basin 10. The fountain further includes a spout 25 disposed over the basin 10 and a spout support 30. The water falls from the spout 25 to the basin 10, and the spout support 30 connects the spout 25 to the basin 10 and supports the spout 25. A pump is disposed in the basin 10 to pump the water in the basin 10 to the spout 25 through a water conduit 52, and the water conduit 52 pass through the spout support 30 such that the water conduit 52 is not visible from outside. A water fill line 54 passes through the access space 40 and the access opening 45 to the basin 10 for supplying water to the basin 10.

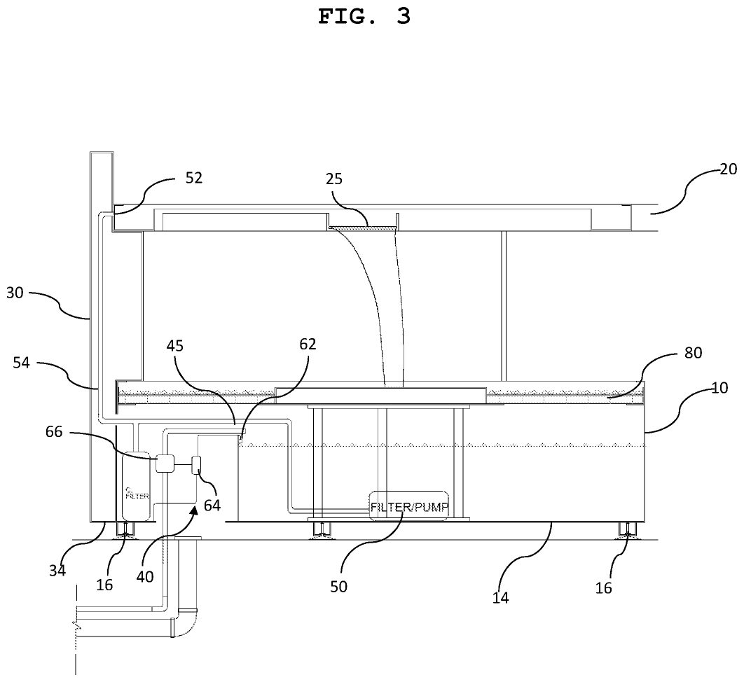

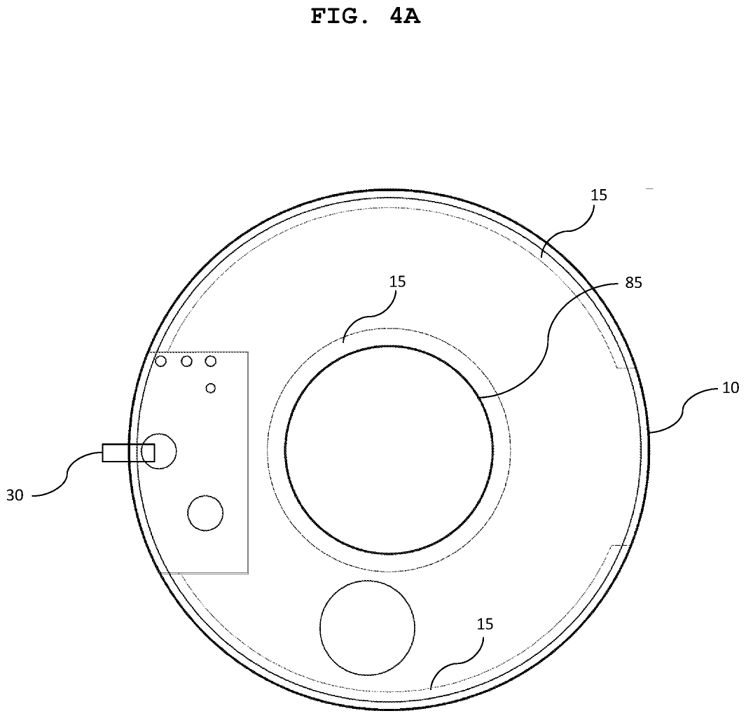

The access space 40 is formed by a cutout into the side 12 of the basin 10 as shown in FIGS. 1A, 1B and 3. Here, “cutout” means that without it, the basin 10 has a more complete recognizable shape such as a circle, oval, rectangle, heart, leaf, geometric shape, etc. By looking at the design of the basin 10, it is easy to come up with the complete shape of the basin if the cutout access space 40 is continuously filled.

The access space 40 (or the dry zone 40) houses most or all of the dry components. The access space 40 is located above ground and is separated and sealed from the basin 10 of the fountain 100 but still is integrated with the fountain 100. Furthermore, despite being sealed from the basin 10, the access space 40 is open to the ground or a concrete slab below. As shown in FIG. 3, the dry components that can be stored in the access space 40 of the fountain 100 include a cartridge filter, a water conduit 52, an auto water fill line 54 that sources the water from a domestic source via a water leveling system 60, and power lines 70, 75. A drain shown in FIG. 3 is preferably located right below the access space 40, and the drain is constructed to direct into it any potential spillover that finds its way there such that the access space 40 (or dry zone 40) is maintained dry.

Additionally, other dry components include the auto-fill device 60 and an electrical housing such as a junction box (preferably waterproof) that includes components that provide power to the pump and any lighting display elements 26 for the fountain 100 (e.g. a transformer for low voltage lighting). As shown in FIGS. 1A, 1B, and 3, the water fill line 54 supplies water to the basin 10 of the fountain 100 and is connected to the auto-fill device 60 (or the water leveling system 60). The access space 40 allows these critical components of the fountain—particularly those that affect power, water supply or circulation, and drainage of the fountain—to remain above the ground such that the installation thereof requires minimal excavation of the immediate area around and about the fountain 100. A drain located below the dry zone 40 is constructed to direct into it any potential spillover that finds its way there such that the dry zone is maintained dry. Additionally, the servicing and, if necessary, the replacement of these components do not require excavating the area around and about the fountain because these components are easily accessible when stored in the access space 40.

The fountain 100 may further include a filter, preferably a cartridge filter as shown in FIG. 3, to filter water which passes through the water conduit. Preferably, the filter is located in the access space 40 for easy maintenance.

The access space 40 borders with the basin 10 by a part of the side 12 of the basin 10. As shown in FIGS. 1A, 1B and 3, the access opening 45 may be formed on upper part in the part of the side 12 of the basin 10, and the upper part has to be above a maximum water level to prevent overflow from the basin 10. The top of the access space 40 may be covered. In the alternative embodiment, the access opening 45 may be formed on top of the access space 40. In still another embodiment, the access opening 45 is formed on both of top of the access space 40 and side 12 of the basin 10.

Preferably, the bottom of the access space 40 is open to ground and the top of the access space 40 is open as well. The pump 50 is preferably an integral filter pump to pump water to the water conduit 52 to the spout 25 of the fountain 100.

The fountain 100 may further include a water leveling system 60. The water leveling system 60 comprises a water level sensor line 62, a control box 64, and a valve 66. The water level sensor line 62 is installed on an inner side of the basin 10 near the access opening 45 for easy access and connected to the control box 64, and the valve 66 is disposed on the water fill line 54 in the access space 40. The control box 64 is disposed in the access space 40 and connected to the valve 66 for turning the valve 66 on or off. Preferably, a solenoid valve 66 is used to turn on the water flow when the water level is below the preset water level and turn off the water flow when the water level is over the preset water level.

The fountain 100 additionally includes a power line 70 for the pump 50 which passes through the access space 40 and the access opening 45 to provide power to the pump 50.

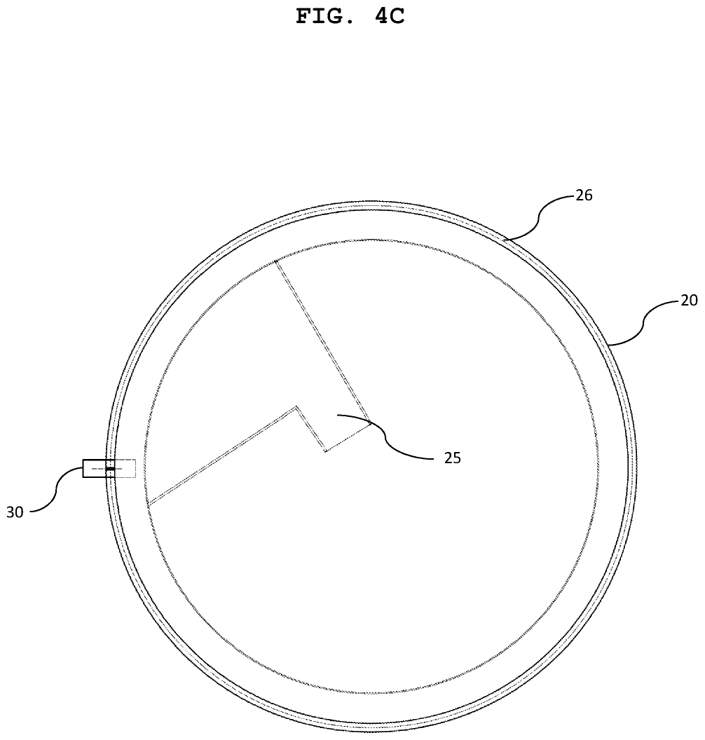

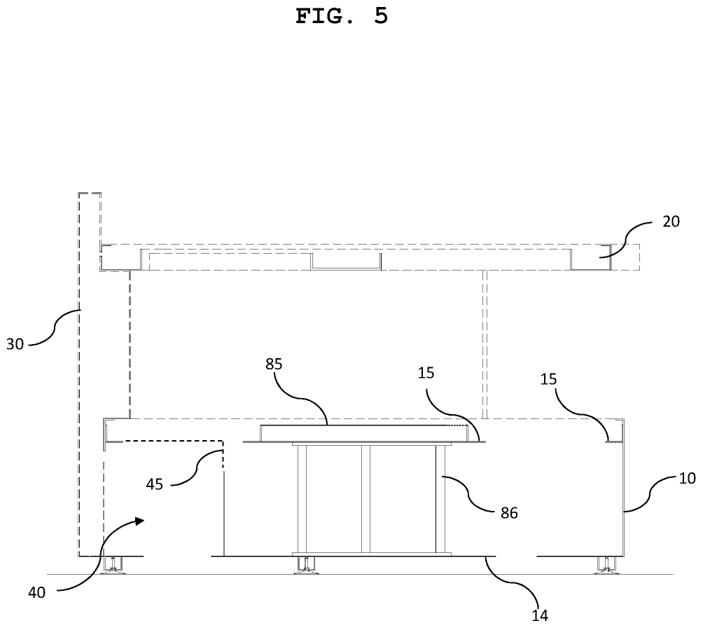

Preferably, the spout support 30 may further extend downwardly along the access space 40 as in FIGS. 3 and 5 such that a bottom 34 of the spout support 30 is about the same level as the bottom 14 of the basin 10.

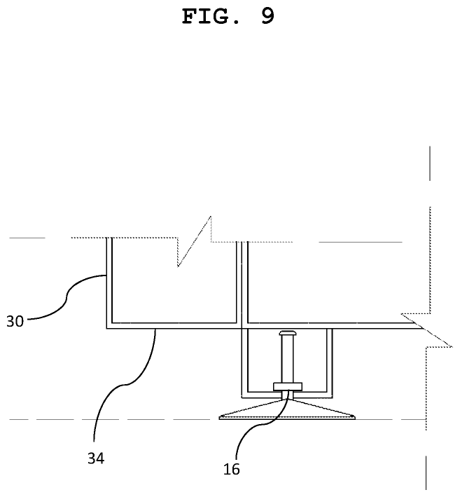

As shown in FIGS. 3, 5, and 9, the fountain 100 further includes a plurality of leveling mounts 16 to adjust the leveling of the fountain 100. One of the leveling mounts 16 is installed on the bottom 34 of the spout support 30, and others are installed on the bottom 14 of the basin 10.

The plurality of leveling mounts 16 secure the fountain to the area as well as provide a means to adjust the leveling of the fountain 100 to achieve a desired level of operation of the fountain 100 and/or for a preferred aesthetic view of the fountain 100. The leveling mounts 16 are installed underneath the basin 14 of the fountain 100 to raise the fountain 100 slightly above ground. Furthermore, the use of such mounts 16 for the fountain 100 allows the fountain 100 to be more easily transported from one location to another. Additionally, any problems associated with the fountain may be spotted earlier with the fountain sitting slightly above ground.

Also shown is the basin 10 of the fountain 100. The basin 10 of the fountain 100 may be substantially circular. For other configurations of the fountain such as a scupper-type or a bud-type, the basin may adopt other shapes such as substantially triangular, substantially rectangular, substantially elliptical, substantially prismatic, or any polyhedral or polygonal shape, heart or leaf, etc. The basin 10 may be shaped from any metal or other materials known in the art. As shown, a portion of the basin 10 is reserved for the construction of the dry zone 40 to house the dry components. As explained above, the dry zone 40 is constructed to be sealed from the basin 10 to prevent any water from the water-filled basin 10, as shown in FIG. 3, to find its way into the dry zone 40 and thus damaging the dry components therein.

Within the basin 10 lies the pump and filter system 50 that is constructed and configured to lie submerged below the water line of the basin 10. The pump and filter system 50 filters and pumps the water delivered from the spout 25 back to the water conduit 52 as shown in FIG. 3 to be re-circulated as part of the outflow from the spout 25 of fountain 100 as a way to reasonably conserve the amount of water used by the fountain 100 as well as to create an event (water with or without lighting) that is pleasing (aesthetically and/or aurally) to observer.

The fountain 100 may further include a grating 80 to cover the basin 10 and a water tray 85. The grating 80 is disposed about or above a maximum water level, and the grating 80 has a hole 82 to receive the water tray 85. Furthermore, the water tray 85 and the basin 10 have lips 15 to hold the grating 80 in place. There are supports 86 to support the water tray 85 from an inner bottom 14 of the basin 10.

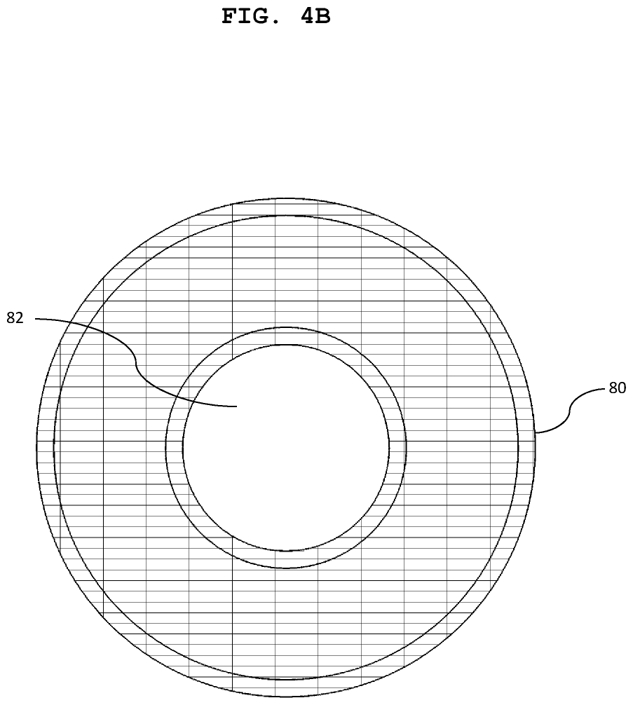

The fountain 100 may be constructed to be multi-tiered. As shown in FIGS. 4A, 4B, 4C, 5, and 6, the fountain 100 may further include the grating 80 and the upper basin 20 such that the spout 25 is disposed on the upper basin 20.

A plurality of lighting sources 26 may be installed on the upper basin 20. A power line 75 for the lighting sources 26 passes through the access space 40 and the spout support 30 to the lighting sources 26 to power the lighting sources 26. Lighting sources may be LEDs or any other sources known in the art.

The grating 80 is disposed at least about or above the water line of the basin 10, and the upper basin 20 (or the upper ring 20) is disposed above the grating 80 and the basin 10. As shown, the grating 80 of FIG. 4B may be constructed to hold pebbles or other materials to create a zen-garden-like minimalistic effect while simultaneously covering the waterline of the basin 10. Additionally, the grating 80 is preferably disposed above the dry zone 40. Furthermore, the grating 80 may be constructed to be disposed above the water line of the basin 10. The top of the access space 40 is open to the grating 80. This top opening may function as an access opening 45, or the access opening may be formed on the side 12 of the basin 10, or both. The access opening 45 permits supply lines (power and/or water) to be passed through. In the alternative embodiment, the top of the access space 40 may be covered to direct water falling from the basin 10 to the water pool of the basin 10.

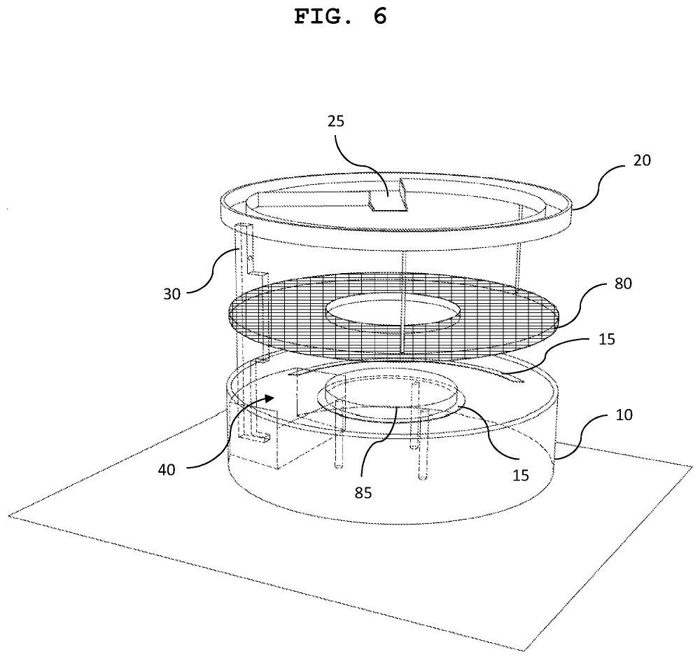

As shown in FIG. 4B, a hole 82 through a central area of the grating 80 is preferred so that a water tray 85 that is shown in FIG. 6 is disposed at about or through the hole 82 of the grating 80. As shown, the water tray 85 also includes a lip 15 to form part of a catch to hold the grating 80 in place. Also shown is a lip 15 constructed in an inner portion of the basin 10 to form another part of the catch for supporting the grating 80. Furthermore, the water tray 85 is held and supported by at least one support 86 that may be coupled to or welded on an interior floor of the basin 10. If coupled, the water tray 85 as well as many of the elements of the fountain 100 can be part of a modular design to simplify the installation process of the fountain 100 as well as provide the ability for manufacturers and designers to design variations of individual elements or components of the fountain 100 to achieve a unique look to the fountain 100. The grating 80 may be made out of metal, fiberglass, or any other metal alloy or composite materials.

The dry zone 40 can be constructed underneath the grating 80 as shown in FIG. 3 or can be slotted under the grating 80, the latter of which permits the dry zone to be brought into the water event. As mentioned earlier, since the dry zone 40 includes components involved in controlling the power, drainage, and water circulation, there is a lack of a need to use chemical treatments for the water since devices used to filter the water or control the pumps working with the filter can be located within the fountain setup, which includes those housed within the dry zone 40. Since chemical treatment can be avoided in this fountain embodiment, there is no need to perform costly construction of a direct connection to a sewage line.

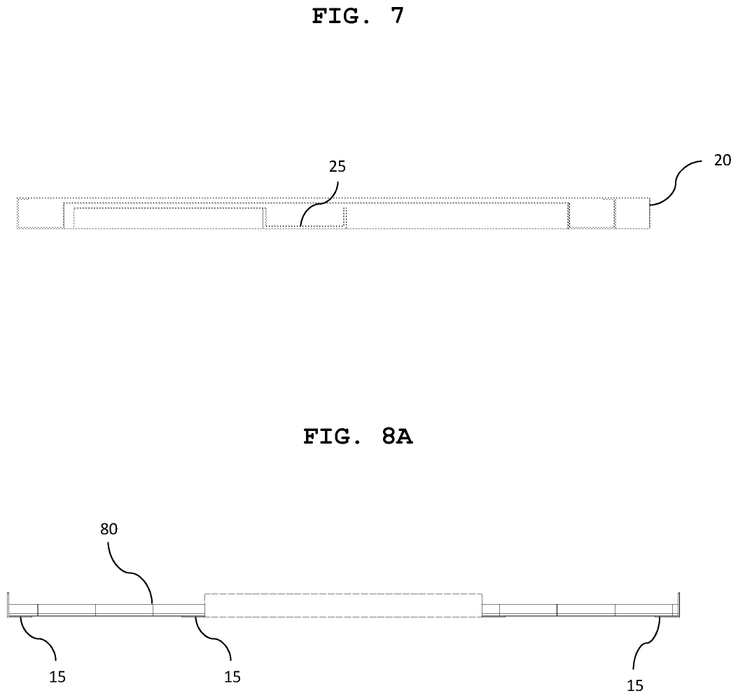

The upper ring 20 shown in FIGS. 1A, 1B, 6, and 7 forms an upper basin 20 for water to collect and traverse towards the spout 25 and then downwards to the basin 10 that sits below. The upper basin 10 formed by the upper ring 10 may include pebbles and other materials. The upper ring is supported by an upper basin support 30 as shown in FIG. 6. The upper basin support 30 (or the water supply column 30) is semi-hollow and includes a bottom opening and a top opening. The bottom opening and top opening of the water supply column allows the water fill line, as shown in FIG. 3, to traverse an interior of the water supply column 30 where the water fill line 52 transports water from the pump and filter system 50, as well as any water supplied from the cartridge filter, to the upper ring basin 20. The water supply column 30 is connected between the basin 10 and the upper ring 20 as shown in FIGS. 1A, 1B, 3, 5, and 6. The upper ring 20 is further supported by support posts as shown in FIGS. 1A, 1B, and 6. The water supply column 30 is not necessarily columnar or substantially columnar. The water supply column 30 can adopt any shape so long that it connects the basin 10 to the upper ring/second basin 20 to provide a conduit for the water fill line 52.

Alternatively, the upper ring 20 and the water supply column 30 may be integrated together as a single structure shown in the scupper-type fountain. The scupper-type fountain includes a lower basin 10 that receives and collects water; an upper basin 20 that receives and delivers water to the lower basin 10; a spout 25 disposed on the upper basin 20; a grating 80; dry components; a dry zone 40 constructed to house most or all of the dry components; a pump filter system 50 to pump water from a source to the spout 25 of the fountain 100; and a solenoid valve 66 to control water flow. For the scupper-type fountain, the upper ring 10 of the earlier-described embodiment is more akin to the upper basin 10 here where water is transported thereto via a water supply column 30 where it temporarily collects before heading towards the spout 25 of the upper basin 20 of the scupper-type fountain. From the spout 25, the water then falls to the basin 10 below. As shown, the water supply column 30 and the upper basin 20 are integrated together. The water tray 85 of the earlier-described embodiments may be included in the scupper-type fountain, but it isn't necessary as shown. The lower basin 10 and the grating 80 need not be substantially circular as in the ring-type fountain described earlier. As shown, the grating 80 that holds pebbles (or any other material) may adopt a unique non-symmetrical polygonal shape.

Also shown, the fountain 100 of the present invention may be adapted to a variety of different shapes and designs. The ring-type and the scupper-type fountains have already been extensively discussed above. The runnel-type fountain as shown is a simplified version of the ring-type fountain where an upper basin is about the same width as the water supply column and sits at about at a right angle from the water supply column. There the upper basin can collect and permit water to flow down to the water tray (and then to the basin) below. The runnel-type fountain may easily be integrated with the natural landscape to provide a distinctive visual appearance. The fountain of the various embodiments may also be applied to bud-type, saucer-type, and skim-type fountains as shown.

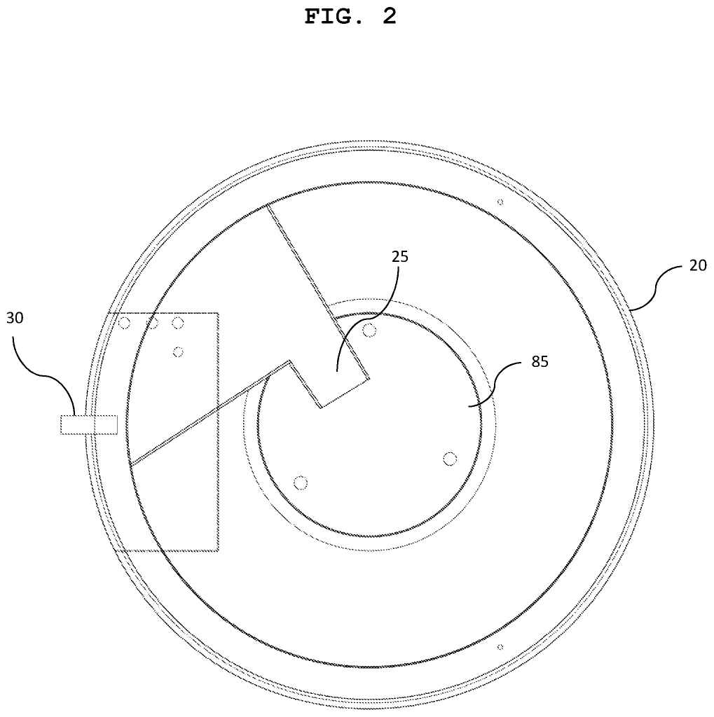

Still in the alternative embodiment as shown in FIGS. 1A, 1B, and 2, the fountain 100 may include a lower basin 10 for storing water, an access space 40 formed by a cutout into the side 12 of the lower basin 10, and an upper basin 20 disposed over the lower basin 10. The lower basin 10 has a side and a bottom 14, and the upper basin 20 has a spout 25 such that the water falls from the spout 25 to the lower basin 10. The access space 40 has an access opening 45 to inside of the lower basin 10.

The fountain 100 further includes an upper basin support 30 connecting the upper basin 20 to the lower basin 10 and supporting the upper basin 20, a water conduit 52 through which the water travels from the lower basin 10 to the upper basin 20, a pump 50 disposed in the lower basin 10 to pump the water in the lower basin 10 to the water conduit 52 and then to the upper basin 20, a water fill line 54 which passes through the access space 40 and the access opening 45 to the lower basin 10 for supplying water to the lower basin 10, a power line 70 for the pump 50 which passes through the access space 40 and the access opening 45 to provide power to the pump 50, and a plurality of lighting sources 26 installed on the upper basin 20. The water conduit 52 passes through the upper basin support 30, and a power line 75 for the lighting sources 26 passes through the access space 40 and the upper basin support 30 to the lighting sources 26 to provide power to the lighting sources 26.

The access space 40 borders with the lower basin 10 by a part of the side 12 of the lower basin 10. The access opening 45 is formed on upper part in the part of the side 12 of the lower basin 10, and the upper part is above a maximum water level. The top of the access space 40 may be covered. Alternatively, the access opening 45 is formed on top of the access space 40. In still another embodiment, the access opening 45 is formed on both of top of the access space 40 and side 12 of the basin 10.

Preferably, the bottom of the access space 40 is open and the top of the access space is open as well.

The water leveling system 60 includes a water level sensor line 62, a control box 64, and a valve 66. The water level sensor line 62 is installed on an inner side 12 of the lower basin 10 near the access opening 45 and connected to the control box 62, and the valve 66, preferably a solenoid valve, is disposed on the water fill line 54 in the access space 40. The control box 64 is disposed in the access space 40 and connected to the valve 66 for turning the valve 66 on or off.

The upper basin support 30 extends downwardly along the access space 40 such that a bottom 34 of the upper basin support 30 is about the same level as the bottom 14 of the lower basin 10. The fountain 100 further comprises a plurality of leveling mounts 16 to adjust the leveling of the fountain 100. One of leveling mounts 16 is installed on the bottom 34 of the upper basin support 30, and others are installed on the bottom 14 of the lower basin 10.

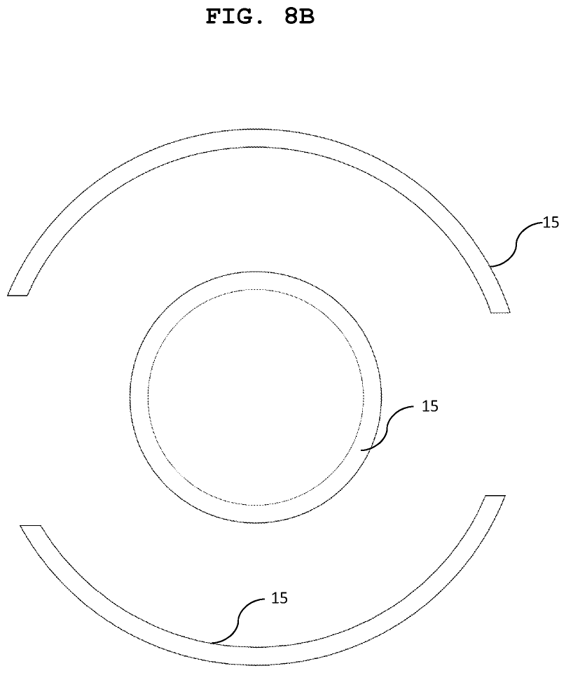

The fountain 100 further includes a grating 80 to cover the lower basin 10 where the grating 80 is disposed about or above a maximum water level. The fountain 100 further comprises a water tray 85, and the grating 80 has a hole 82 as shown in FIG. 8A to receive the water tray 85. The water tray 85 and the lower basin 10 have lips 15 to hold the grating 80 in place as shown in FIGS. 8A and 8B.

In one embodiment, the lower basin 10 is circular, and the upper basin 10 is circular as well. The upper basin 20 has a substantially circular hole 28, and the spout 25 extends into the circular hole 28.

While the invention has been shown and described with reference to different embodiments thereof, it will be appreciated by those skilled in the art that variations in form, detail, compositions, and operation may be made without departing from the spirit and scope of the invention.

What is claimed is:

1. A fountain, comprising:
a basin for storing water, which has a side and a bottom;
an access space formed by a cutout into the side of the basin, wherein the access space has an access opening to inside of the basin;
a spout disposed over the basin wherein the water falls from the spout to the basin;
a spout support connecting the spout to the basin and supporting the spout;
a water conduit through which the water travels from the basin to the spout wherein the water conduit passes through the spout support;
a pump disposed in the basin to pump the water in the basin to the water conduit and then to the spout; and
a water fill line which passes through the access space and the access opening to the basin for supplying water to the basin.

2. The fountain of claim 1, wherein the access space borders with the basin by a part of the side of the basin,
wherein the access opening is formed on upper part in the part of the side of the basin, and
wherein the upper part is above a maximum water level.

3. The fountain of claim 2, wherein a bottom of the access space is open and a top of the access space borders with a part of the bottom of the basin.

4. The fountain of claim 3, further comprising a water leveling system wherein the water leveling system comprises a water level sensor line, a control box, and a valve,
wherein the water level sensor line is installed on an inner side of the basin near the access opening and connected to the control box,
wherein the valve is disposed on the water fill line in the access space;
wherein the control box is disposed in the access space and connected to the valve for turning the valve on or off.

5. The fountain of claim 4, further comprising a power line for the pump which passes through the access space and the access opening to provide power to the pump.

6. The fountain of claim 1, wherein the spout support extends downwardly along the access space such that a bottom of the spout support is about the same level as the bottom of the basin.

7. The fountain of claim 6, further comprising a plurality of leveling mounts to adjust the leveling of the fountain, and wherein one of the leveling mounts is installed on the bottom of the spout support.

8. The fountain of claim 1, further comprising a grating to cover the basin wherein the grating is disposed about or above a maximum water level.

9. The fountain of claim 8, further comprising a water tray, wherein the grating has a hole to receive the water tray, wherein the water tray and the basin have lips to hold the grating in place.

10. The fountain of claim 9, further comprising a support to support the water tray from an inner bottom of the basin.

11. The fountain of claim 1, further comprising an upper basin, wherein the spout is disposed on the upper basin.

12. The fountain of claim 11, wherein a plurality of lighting sources are installed on the upper basin, wherein a power line for the lighting sources passes through the access space and the spout support to the lighting sources to power the lighting sources.

13. A fountain, comprising:
a lower basin for storing water, which has a side and a bottom;
an access space formed by a cutout into the side of the lower basin, wherein the access space has an access opening to inside of the lower basin;
an upper basin disposed over the lower basin wherein the upper basin has a spout and the water falls from the spout to the lower basin;
an upper basin support connecting the upper basin to the lower basin and supporting the upper basin;
a water conduit through which the water travels from the lower basin to the upper basin wherein the water conduit passes through the upper basin support;
a pump disposed in the lower basin to pump the water in the lower basin to the water conduit and then to the upper basin;
a water fill line which passes through the access space and the access opening to the lower basin for supplying water to the lower basin;
a power line for the pump which passes through the access space and the access opening to provide power to the pump; and
a plurality of lighting sources installed on the upper basin, wherein a power line for the lighting sources passes through the access space and the upper basin support to the lighting sources to provide power to the lighting sources.

14. The fountain of claim 13, wherein the access space borders with the lower basin by a part of the side of the lower basin and the access opening is formed on upper part in the part of the side of the lower basin, wherein the upper part is above a maximum water level.

15. The fountain of claim 14, wherein a bottom of the access space is open and a top of the access space borders with a part of the bottom of the lower basin.

16. The fountain of claim 15, further comprising a water leveling system wherein the water leveling system comprises a water level sensor line, a control box, and a valve,
wherein the water level sensor line is installed on an inner side of the lower basin near the access opening and connected to the control box,
wherein the valve is disposed on the water fill line in the access space;
wherein the control box is disposed in the access space and connected to the valve for turning the valve on or off.

17. The fountain of claim 13, wherein the upper basin support extends downwardly along the access space such that a bottom of the upper basin support is about the same level as the bottom of the lower basin,
wherein the fountain further comprises a plurality of leveling mounts to adjust the leveling of the fountain, and
wherein one of leveling mounts is installed on the bottom of the upper basin support.

18. The fountain of claim 13, further comprising a grating to cover the lower basin wherein the grating is disposed about or above a maximum water level,
wherein the fountain further comprises a water tray,
wherein the grating has a hole to receive the water tray, and
wherein the water tray and the lower basin have lips to hold the grating in place.

19. The fountain of claim 18, further comprising a support to support the water tray from an inner bottom of the lower basin.

20. The fountain of claim 13, wherein the lower basin is circular, and the upper basin is circular,
wherein the upper basin has a substantially circular hole, and
wherein the spout extends into the circular hole.
